(19) United States
(12) Patent Application Publication
(10) Pub. No.: US 2020/0377003 A1
(43) Pub. Date: Dec. 3, 2020

(54) Strap Winder Lock

(71) Applicant: Donald S Egigian, Boerne, TX (US)

(72) Inventor: Donald S Egigian, Boerne, TX (US)

(21) Appl. No.: 16/423,070

(22) Filed: May 27, 2019

(51) Int. Cl. B60P 7/08

(52) U.S. Cl. CPC B60P 7/0846; B60P 7/0838

(57) ABSTRACT

A strap winder for a ratchet cargo strap, having a rotating spool for receiving a strap and a winding arm and knob to rotate the spool and wind up a strap on the spool. A sliding locking pin on the winding arm and knob locks the spool from rotation to retain a stored strap on the spool and a plurality of locking apertures in the strap winder frame receive the locking pin to lock the arm and spool from rotation.

A lock tab on the winding arm engages a lock on the knob when the locking pin is inserted into locking aperture on rotated to a locked position.

### CROSS-REFERENCE TO RELATED APPLICATIONS

NA

### STATEMENTS REGARDING FEDERALLY SPONSORED RESEARCH OR DEVELOPMENT

NA

### REFERENCE TO A MICROFICHE APPENDIX

NA

### BACKGROUND OF THE INVENTION

### 1. Field of the Invention

The invention relates to a strap winder lock for a ratchet cargo strap that stores the unused strap after securing the two ends of the ratchet cargo strap to two opposed attachment points on a vehicle, trailer or other transport and tightening the cargo strap to secure materials from shifting and locking it tightly.

### 2. Description of the Related Art

The invention relates to a strap winder lock for ratchet cargo straps. Ratchet cargo straps are well known in the prior art for acting as a tie-down for cargo on a vehicle or transport.

### BRIEF SUMMARY OF THE INVENTION

The invention comprises a strap winder for a ratchet cargo strap having a rotating spool for receiving a strap and a winding arm and knob to rotate the spool and wind up a strap on the spool. The strap winder has a locking pin on the winding arm and knob to lock the spool from rotation to retain a stored strap on the spool. A plurality of locking apertures in the strap winder frame receives the locking pin to lock the arm and spool from rotation.

The locking pin is slidably mounted on the winding arm and knob to lock the spool from rotation to retain a stored strap on the spool in one of a plurality of locking apertures in the strap winder frame for receiving the locking pin to lock the arm and spool from rotation. A lock tab on the winding arm engages a lock on the knob when the locking pin is inserted into locking aperture.

An object to the invention is to provide a strap winder that can be locked to retain a cargo strap on the strap winder.

Other objects of the invention will be apparent from the following drawings and detailed description of the preferred embodiment.

### BRIEF DESCRIPTION OF THE SEVERAL VIEWS OF THE DRAWINGS

FIG. 1 is a perspective view of the cargo strap winder for a tie strap.

FIG. 2 is a side elevation view of the cargo strap winder with the base at the top.

FIG. 3 is a side elevation view of the other side of the cargo strap winder.

FIG. 4 is a side end elevation view of the cargo strap winder.

FIG. 5 is a side end elevation view of the other side of the cargo strap winder.

FIG. 6 is a top view of the cargo strap winder.

FIG. 7 is a bottom view of the cargo strap winder.

FIG. 8 is a perspective view of the cargo strap winder with the base at the bottom.

FIG. 9 is a perspective view of the cargo strap winder showing it attached to a ratchet cargo strap.

FIG. 10 is an exploded view showing the components of the cargo strap winder.

FIG. 11 is a perspective view of another embodiment of the cargo strap winder for a tie strap.

FIG. 12 is an exploded view showing the components of the other embodiment of the cargo strap winder.

FIG. 13 is an elevation view showing the components of the other embodiment of the cargo strap winder in cross section.

### DETAILED DESCRIPTION OF THE INVENTION

The above-listed and described drawing figures illustrate at least one of the preferred embodiments of the invention, which is further defined in detail in the following detailed description of the invention.

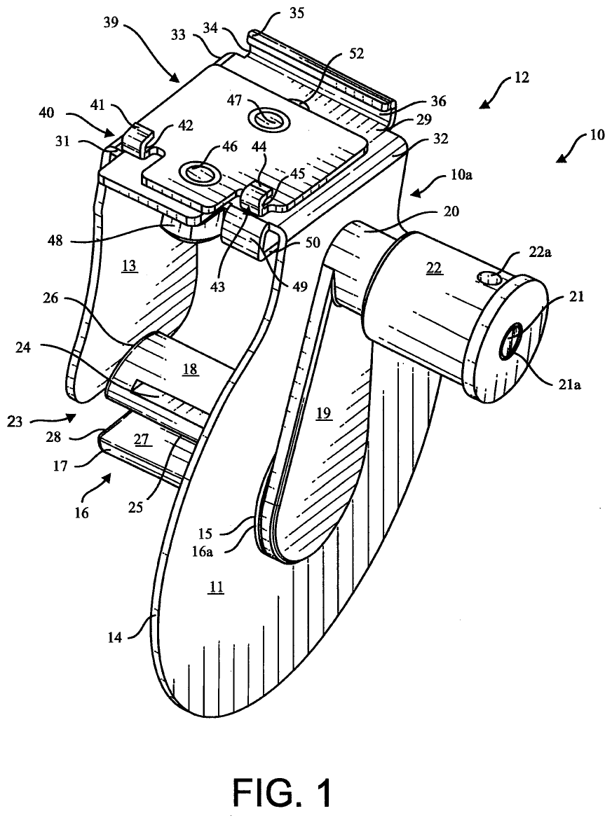

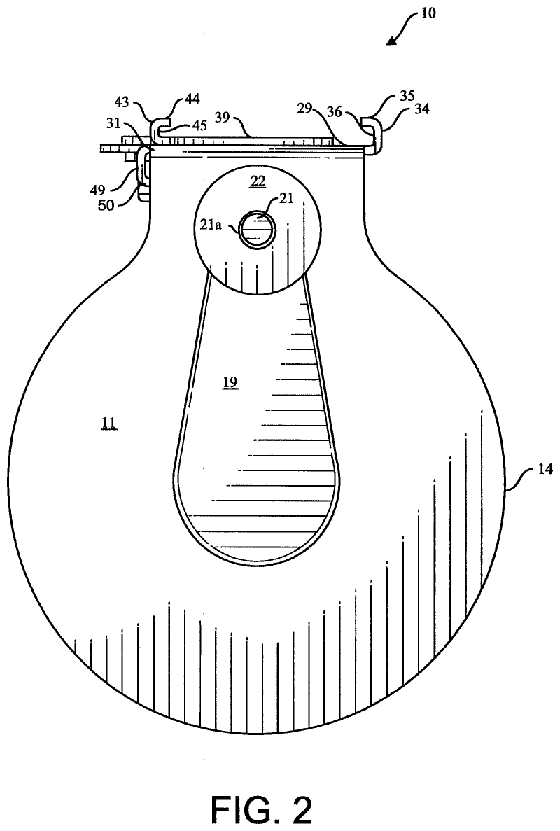

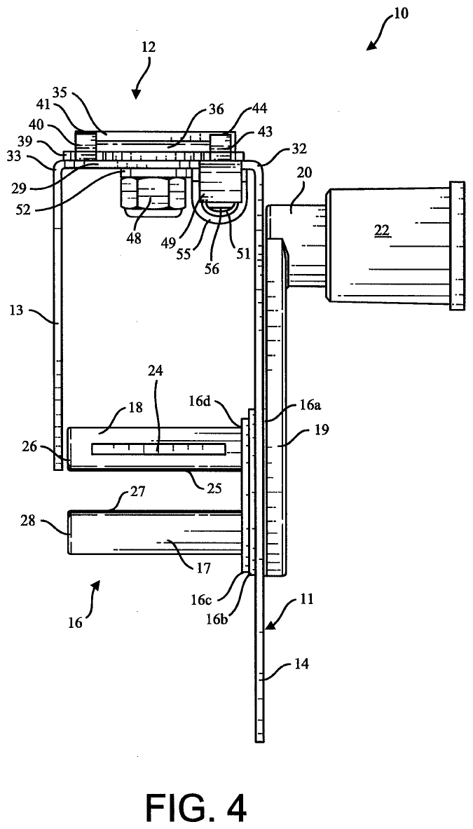

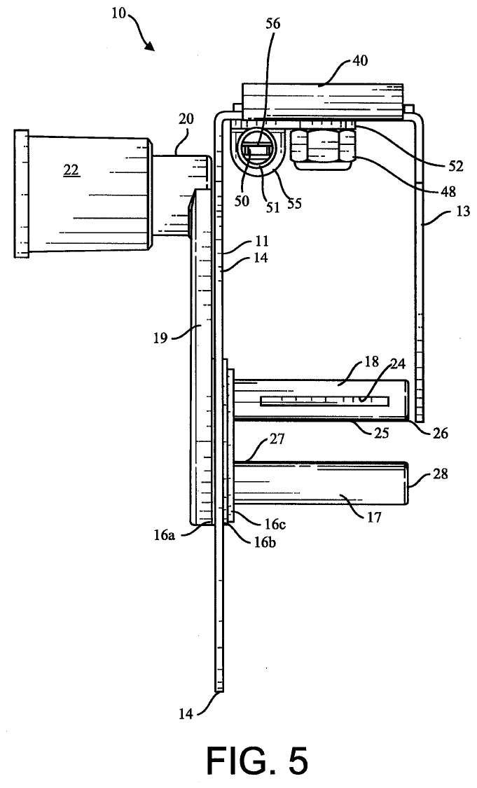

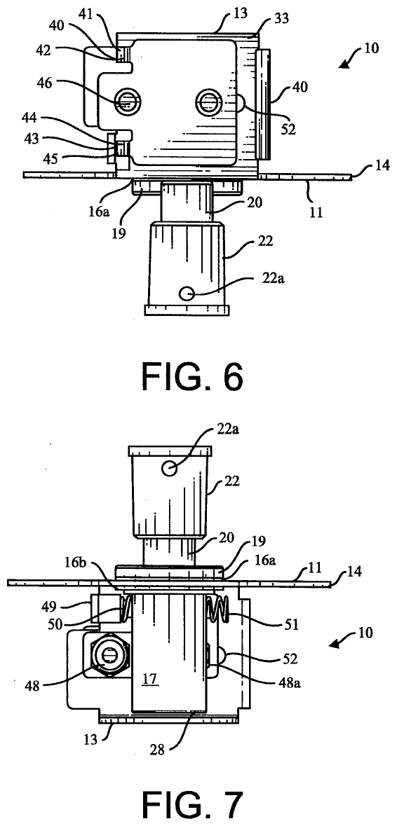

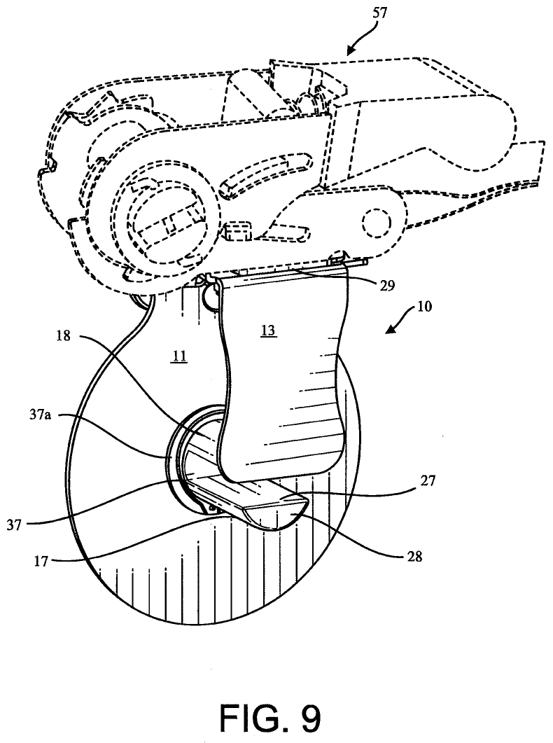

The present invention is a cargo strap winder 10 is shown in FIGS. 1-10. The strap 10 is designed to be releasably attached to a ratchet cargo strap 57 shown in FIG. 9. The ratchet cargo strap 57, shown in broken lines in FIG. 9, is standard and well known in the art. As show in FIGS. 1, 4-5, the cargo strap winder has a generally U-shaped frame 10. The strap winder frame 10 includes a rounded side leg 11 extending downwardly from one side of rectangular strap winder base 12 and a second rectangular side leg 14 extending perpendicularly downwardly from the other side of the winder base 12. The rounded side leg 11 includes a rounded edge 14.

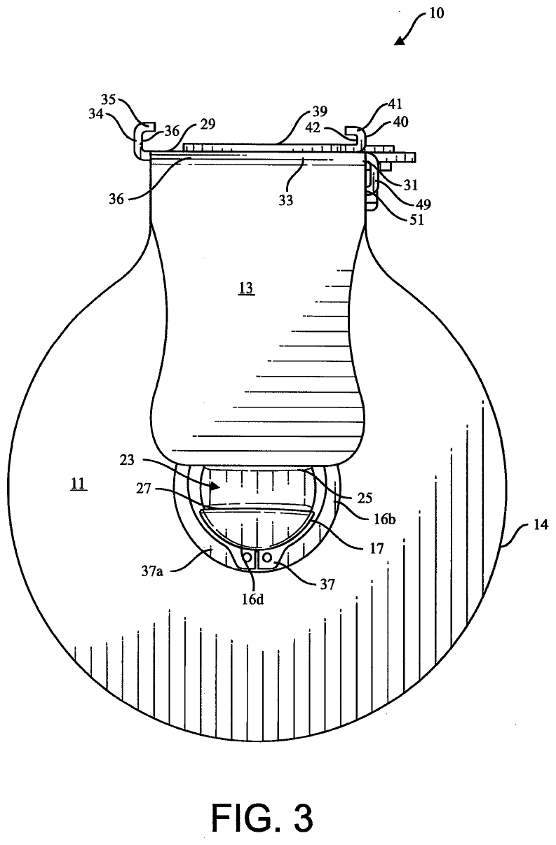

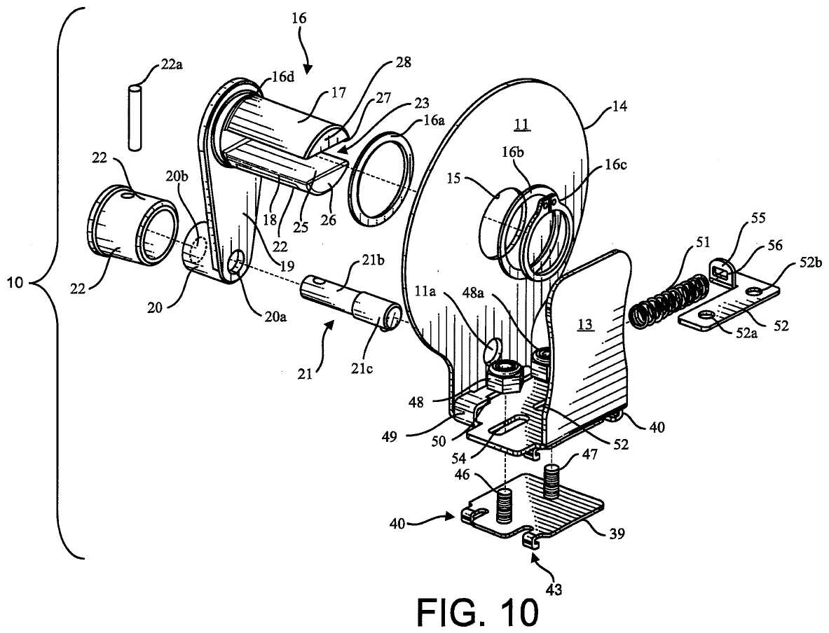

A round aperture 15 is formed in the center of the side leg 11 as shown in FIG. 10. As shown in FIGS. 1, 4-5 and 10, a strap-receiving spool 16 extends through the aperture 15. Washers 16a and 16b are mounted on each side of the aperture 15. Referring to FIGS. 3-4 and 10, a spring retaining clip 16c is releasably inserted in a spring retaining slot 16d in the spool 16 to retain the spool in place and so that it will rotate in the aperture 15.

The strap-receiving spool includes an elongated arcuate-shaped spool portion 17 and an opposed elongated arcuate-shaped spool portion 18. The winding arm 19 is secured to the spool 16. A round knob support bushing 20 is secured to arm 19 perpendicular thereto. As shown in FIG. 9, an inner aperture 20a extends from the outer smaller aperture 20b in knob support 20. The smaller aperture 20b is the slightly larger than the small shaft portion 21b so it can slide therein. The inner aperture is slightly larger than the larger shaft portion 21c so it can slide therein. The winding knob shaft 21 extends through apertures 21a and 21b in the knob support bushing 20 and is rotatable relative to the winding arm 19. The winding knob shaft 21 includes a shaft portion 21b that is larger than the aperture 20a to retain it in the aperture 20a.

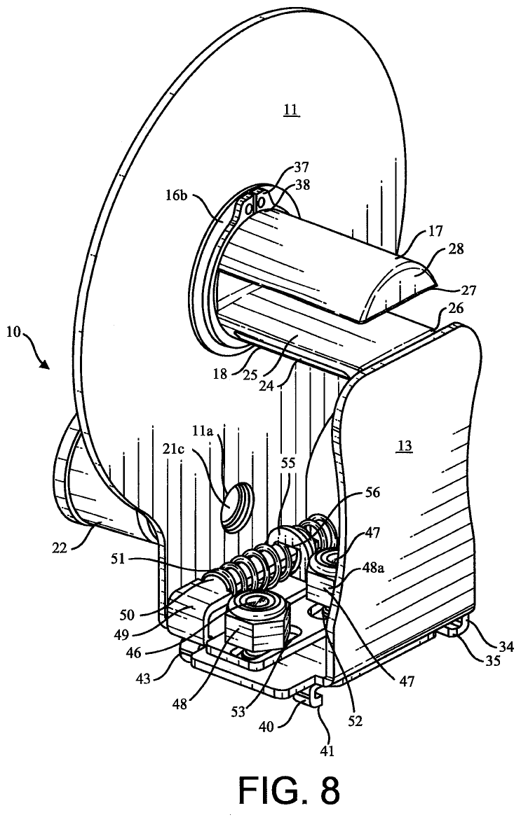

The shaft 21 include a second smaller cylindrical portion 21b that is slightly smaller than the aperture 20b. This allows the smaller portion 21b to freely rotate in the aperture 20b. The length of the smaller cylindrical portion 21b is sufficient to allow the winding knob and cylindrical shaft to move toward and away from the leg 11. An aperture 11a in the leg 11, shown in FIG. 8, received the end of the shaft 21c to act as a lock preventing rotation of the spool 16. A rotating knob 22 is secured to the end of the smaller cylindrical portion 21b by slotted locking spring pin0 22a that extends through apertures in the rotating knob and smaller cylindrical portion 21b to secure the knob 22 to the cylindrical shaft portion 21b.

The spool 16 includes an elongated slot 23 for receiving the end of a strap if a standard cargo ratchet strap. Cargo ratchet straps come in various widths ranging from about 1 inch to 4 inches wide. The lengths of cargo ratchet straps may vary from about 10 feet to 60 feet. The size of the cargo strap winder 10 can vary according to the size of the cargo ratchet strap.

The cylindrical strap receiving spool 16 includes an elongated slot 24 in the arcuate shaped spool portion 18 for receiving a strap end. The spool portion 18 includes a flat surface 25 which comes in contact with the strap when it is inserted in the slot. The spool portion 17 includes a flat surface 27. The spool portion 18 includes a flat end surface 26 that is adjacent to and closely spaced to the rectangular side leg 13 to regain the strap on the spoon during winding and unwinding. The spool portion 17 includes a flat surface 27 that forms the slot 23 and comes in contact with the strap when it is inserted in the slot 23. A flat end surface 28 is formed on the spool portion 17 that is adjacent to and closely spaced to the rectangular side leg 13. The spacing of the ends 26 and 28 from the leg 13 helps retain a strap on the spool 16.

The winder base 12 includes a flat upper surface 29. The flat upper surface 29 includes an edge 30 and an opposed edge 31. The flat upper surface 29 also includes a side edge 32 and an opposed side edge 33. An upwardly extending connection tab 34 extends perpendicular to the flat surface 29 at the edge 30. The tap 34 includes a retaining tab 35 extending parallel to the flat surface 29 from the upwardly extending connection tab to form a hook portion for attaching to a cargo ratchet frame. A flat engaging surface 36 engages a cargo ratchet frame edge with the retaining tab holding it in place on the cargo ratchet frame edge.

As shown in FIGS. 1-3, 6-7 and 10, a sliding fastener or strap winder hook subassembly 39 is slidably mounted on the top of the flat surface 29. Connection hook tab 40 extends perpendicular to the flat surface of the sliding fastener 39 and flat surface 29. Connected to the connection tab is a retaining tab 41 which extends parallel to the upper flat surface of the sliding fastener 39 and flat surface 29 to form a hook for connecting to a ratchet strap frame edge. Engaging surface 42 connects to a ratchet cargo strap base frame edge to retain the winder frame in position. A second connection tab 43 extends perpendicular to the upper flat surface of the sliding fastener 39 and flat surface 29. A second retaining tab 44 extends parallel from the end of hook tab 43 and includes a second engaging surface 45 for forming a hook to connecting to the edge of a ratchet cargo strap frame.

Threaded studs 46 and 47 are mounted in the engaging surface of the sliding fastener 39. The studs 46 and 47 extend through slots 53 and 54 in spring slide mount 49 as shown in FIGS. 8 and 10 and apertures 52a and 52b of the sliding plate 52 shown in FIG. 10. Locking taps 48 and 48a mount on the threaded studs 46 and 47 to retain the spring sliding fastener 39 so it can slide back and forth to allow attachment to a ratchet cargo strap 57 frame shown in broken lines in FIG. 9. A spring engaging tab 55 is mounted on the spring slide mount 52 and engages a compression spring 51 that is slidably mounted on the spring slide 50. A slot 56, shown in FIG. 10, in the spring engaging tab allows insertion of the spring 51 on a spring slide 50. The force of the spring 51 on the sliding fastener 39 can be adjusted by positioning the spring engaging tab in a selected position between the ends of the spring 51.

To attach the strap winding 10 to a ratchet cargo strap 57, the engaging surface 36 is hooked over one edge of the ratchet strap and the sliding fastener 39 is slid away from the engaging surface 36 against the force of the spring 51 until the engaging surfaces 43 and 45 can be hooked over a second opposed edge of the ratchet strap. Releasing the sliding fastener 39 releasably locks the strap winder 10 to the ratchet cargo strap 57.

To wind up the loose ratchet strap on to the spool 16 the end of the strap is inserted into the slot 23 and looped around and inserted in the slot 24. Winding the arm 19 with the knob 22 winds the excess strap around the spool 16 to store the unused strap, not shown, in the strap winder 10. The winder arm 19 can be locked from rotation by sliding the knob 22 and larger shaft portion 21c inward into the aperture 11a in leg 11. When it is desired to release the strap the knob 22 and shaft portion 21c are pulled out to release the shaft portion 21c from the locking aperture 11a.

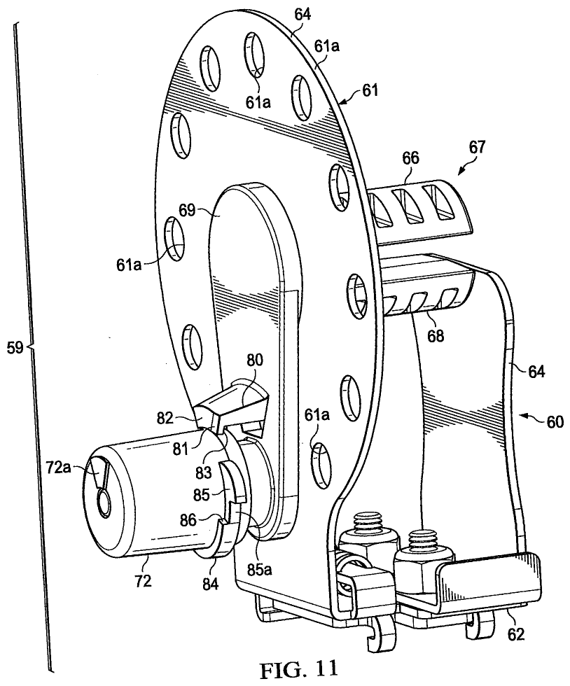

Another embodiment of the cargo strap winder 10 is shown in FIGS. 11-13. The strap winder 59 is designed to be releasably attached to a ratchet cargo strap 57 shown in FIG. 9. As show in FIGS. 11-13, the cargo strap winder has a generally U shaped frame 60. The strap winder frame 60 includes a rounded side leg 61 extending perpendicular from one side of rectangular strap winder base 62 and a second rectangular side leg 64 extending perpendicularly from the other side of the winder base 62. The rounded side leg 61 includes a rounded edge 61a.

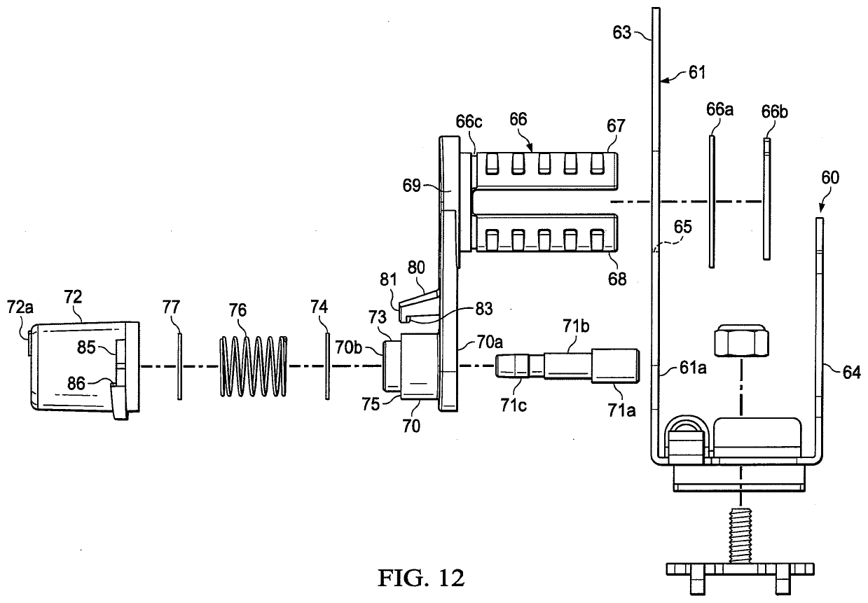

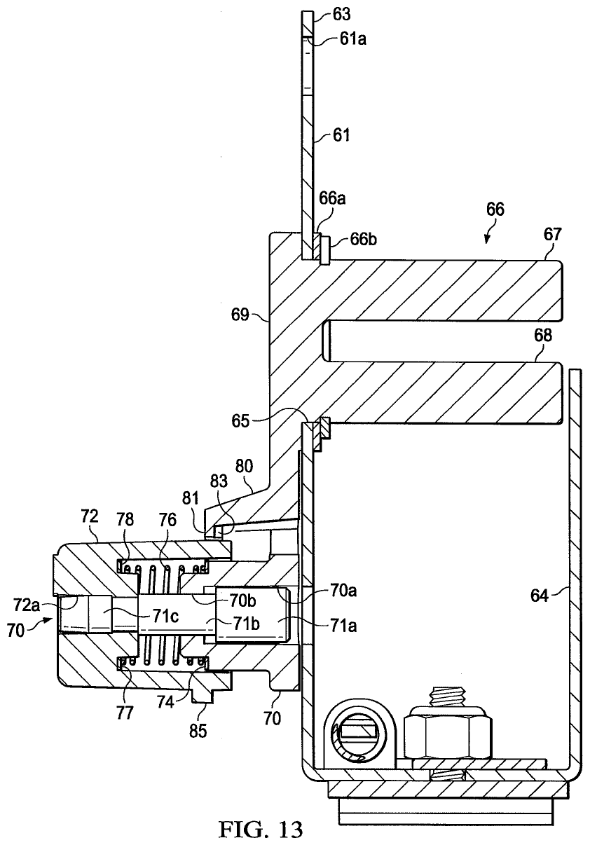

A round aperture 65 is formed in the center of the side leg 61 as shown in FIG. 12-13. As shown in FIGS. 11-13, a strap-receiving spool 66 extends through the aperture 65. Washer 66a and is mounted on one side of the aperture 65. Referring to FIGS. 12-13, a spring retaining clip 66b is releasably inserted in a spring retaining slot 66c in the spool 66 to retain the spool in place and so that it will rotate in the aperture 65. The strap-receiving spool includes an elongated arcuate-shaped spool portion 67 and an opposed elongated arcuate-shaped spool portion 68. The winding arm 69 is secured to the spool 66.

A round knob support bushing 70 is secured to arm 69 perpendicular thereto. As shown in FIGS. 12-13, an inner aperture 70a extends from the outer smaller aperture 70b in knob support 70. The smaller aperture 70b is the slightly larger than the small shaft portion 71b so it can slide and rotate therein. The larger inner aperture 70a is slightly larger than the larger shaft portion 71a so it can slide and rotate therein. The winding knob shaft 71 extends through apertures 71a and 71b in the knob support bushing 70 and is rotatable relative to the winding arm 69. The winding knob shaft 71 includes a shaft portion 71a that is larger than the aperture 70b to retain it in the aperture 70b.

The pin shaft 71 includes a second smaller cylindrical portion 71b that is slightly smaller than the aperture 70b. This allows the smaller portion 71b to slide and rotate in the aperture 70b. The length of the smaller cylindrical portion 71b is sufficient to allow the winding knob and cylindrical shaft to move toward and away from the leg 61. A plurality of apertures 61a are spaced peripherally about the leg 61, shown in FIG. 11, and are sized so they can receive the end of the shaft 71a to act as a lock preventing rotation of the spool 66.

A rotating knob 72 is secured to the end of the smaller cylindrical portion 71c and includes a lock indicator 72a for aligning the knob 72 so it can be pushed in to secure the knob 72 to the cylindrical shaft portion 71c.

The knob support 70 includes a smaller diameter portion 73 as shown in FIG. 12. The smaller diameter portion 73 receives a washer 74 that engages the cylindrical surface 75 on the smaller diameter portion 73. A spring 76 engages the washer 74 and fits over the portion 73 which retains it in position. A second washer 77 engages the cylindrical surface 78 as shown in FIG. 13. The other end of the spring 76 engages the washer 77 when assembled as shown in FIG. 15.

With the knob 72 secured to the shaft 71 as shown in FIG. 13, it can be pushed to the right against the bias of spring 76 and so the cylindrical shaft portion 71a can be inserted into a selected one of the apertures 61a to retain the arm 69 and spool 66 from rotation and retain a strap wrapped around the spool. The knob 72 has a cylindrical opening 72a for receiving and securing to the shaft 71c. The tension of the strap will retain the cylindrical end 71a of the shaft 71 engaged with an aperture 61a. By releasing some of the tension the end 71a will disengage with the aperture 61a and allow rotation of the arm 69 and shaft 66 and winding and unwinding of the spool 66 and strap.

As shown in FIGS. 11 and 12, a locking arm 80 is secured on the leg 64 and includes a lock tab 81 that is secured to the end to the end of the arm 80. An indicator 82 is secured to the tab 81. An inclined cylindrical ramp 85 is secured to the knob 72 and engages the inner surface 83 of the tab 81 and causes the pin 71 to be moved and held inwardly into an aperture 61a in the leg 61 against the bias of the spring 76 as the knob 72 is rotated.

In order to initially insert the pin 71 in the aperture 61a you much align the indicators 72a and 82. After insertion of the pin 71 in a aperture 61a, continued rotation of the knob 72 causes ramp to engage the locking tab 81 and the edge 86 to catch the tab 81 which when rotated to the point that the cut out lock 85a is engaged by the surface 83 of tab 81 which locks the knob in place and prevents further rotation and keeps the pin 71 in an aperture 61a. To release the knob 72 and pin 71 you push in the knob 71 and rotate it counterclockwise to allow knob 72 and ramp to be released from the tab 81 so the pin 71 is fully released and moved out of an aperture 61a so you can rotate the handle 69 and release or tighten the strap.

The above-listed sections and included information are not exhaustive and are only exemplary of the invention. The sections and included information in an embodiment may depend upon the implementation and the included devices and resources. Although a system and method according to the present invention have been described relating to the preferred embodiment, it is not intended to be limited to the specific form set forth herein, but, on the contrary, it is intended to cover such alternatives, modifications, and equivalents, as can be reasonably included within the spirit and scope of the invention as defined by the appended claims.

We claim:

1. A locking strap winder for a ratchet cargo strap, comprising:
A strap winder frame having a rotating spool for receiving a strap and a winding arm and knob to rotate the spool and wind up a strap on the spool;
A sliding locking pin on the winding arm and knob to lock the spool from rotation to retain a stored strap on the spool; and
A plurality of locking apertures in the strap winder frame for receiving the locking pin to lock the arm and spool from rotation.
A lock tab on the winding arm to engage a lock on the knob when the locking pin is inserted into locking aperture.

2. A locking strap winder for a ratchet cargo strap of claim 1, comprising:
Alignment indicators on the knob and lock tab to indicate when pin can be pushed into an aperture.

3. A locking strap winder for a ratchet cargo strap of claim 1, comprising:
A lock ramp on the knob to engage the lock tab and secure the locking pin in a selected aperture upon rotation of the lock ramp to a locked position.

4. A locking strap winder for a ratchet cargo strap of claim 1, comprising:
A shaft secured to the knob and slidably mounted in an aperture in the winding arm to allow the pin staff to be inserted be inserted in a locking aperture to secure the winding arm in a locked position.

5. A locking strap winder for a ratchet cargo strap of claim 1, comprising:
A spring around the knob shaft to bias the locking pin in the released position.

6. A locking strap winder for a ratchet cargo strap of claim 1, comprising:
A spring around the knob shaft to bias the locking pin in the released position.

7. A locking strap winder for a ratchet cargo strap of claim 1, comprising:
A ramp on the knob shaft to hold the locking pin in the locked position.

8. A locking strap winder for a ratchet cargo strap of claim 1, comprising:
A ramp on the knob shaft to hold the locking pin in the locked position and a lock on the ramp to hold it in a locked position.

9. A locking strap winder for a ratchet cargo strap of claim 1, comprising:
The lock tab extends outwardly from the arm for engagement with the knob.
